(19) United States
(12) Patent Application Publication
(10) Pub. No.: US 2016/0073305 A1
(43) Pub. Date: Mar. 10, 2016

(54) RADIO ACCESS TECHNOLOGY CELL RESELECTION

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/480,478

(22) Filed: Sep. 8, 2014

(51) Int. Cl. H04W 36/00; H04W 36/30

(52) U.S. Cl. CPC H04W 36/0083; H04W 36/30

(57) ABSTRACT

A user equipment (UE) quickly reselects from a first radio access technology (RAT) to a third RAT. The first RAT does not provide neighbor frequencies of the third RAT. Therefore, the user equipment first starts reselection to a second RAT. The user equipment then collects system information from the second RAT. The system information includes one or more frequencies of the third RAT. The user equipment searches for one or more frequencies of the third RAT and measures one or more detected cells corresponding to the one or more frequencies of the third RAT. The user equipment bypasses camping on the second RAT and directly camps on the third RAT when a signal quality of a detected cell corresponding to the one or more frequencies is above an absolute threshold.

### BACKGROUND

1. Field

Aspects of the present disclosure relate generally to wireless communication systems, and more particularly, to cell reselection from a first radio access technology (RAT) to a third RAT, when the first RAT does not broadcast neighbor cells of the third RAT.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

One aspect of the present disclosure discloses a method of directly reselecting from a first radio access technology (RAT) to a third RAT and includes collecting system information from a second radio access technology (RAT) when cell reselection from the first RAT to the second RAT is triggered. The system information includes one or more frequencies of the third RAT. The method also includes searching for the one or more frequencies of the third RAT and measuring a detected cell(s) corresponding to the one or more frequencies of the third RAT. When a signal quality of a detected cell of the one or more detected cells corresponding to the one or more frequencies is above an absolute threshold, the UE camps directly on the third RAT and bypasses camping on the second RAT and.

In another aspect of the present disclosure, an apparatus for directly reselecting from a first radio access technology (RAT) to a third RAT includes means for collecting system information from a second radio access technology (RAT) when cell reselection from the first RAT to the second RAT is triggered. The system information includes one or more frequencies of the third RAT. The apparatus also includes means for searching for the one or more frequencies of the third RAT and means for measuring a detected cell(s) corresponding to the one or more frequencies of the third RAT. The apparatus also includes means for bypassing camping on the second RAT and directly camping on the third RAT when a signal quality of a detected cell of the one or more detected cells corresponding to the one or more frequencies is above an absolute threshold.

Another aspect discloses an apparatus for directly reselecting from a first radio access technology (RAT) to a third RAT and includes a memory and at least one processor coupled to the memory. The processor(s) is configured to collect system information from a second radio access technology (RAT) when cell reselection from the first RAT to the second RAT is triggered. The system information includes one or more frequencies of the third RAT. The processor(s) is also configured to search for one or more frequencies of the third RAT and to measure a detected cell(s) corresponding to the one or more frequencies of the third RAT. The processor(s) is also configured to bypass camping on the second RAT and to directly camp on the third RAT when a signal quality of a detected cell of the one or more detected cells corresponding to the one or more frequencies is above an absolute threshold.

In another aspect, a computer program product for directly reselecting from a first radio access technology (RAT) to a third RAT in a wireless network has a non-transitory computer-readable medium. The computer readable medium has non-transitory program code recorded thereon which, when executed by the processor(s), causes the processor(s) to perform the operation of collecting system information from a second radio access technology (RAT) when cell reselection from the first RAT to the second RAT is triggered. The system information includes one or more frequencies of the third RAT. The program code also causes the processor(s) to search for the one or more frequencies of the third RAT and also causes the processor(s) to measure a detected cell(s) corresponding to the one or more frequencies of the third RAT. The program code also causes the processor(s) to bypass camping on the second RAT and to directly camp on the third RAT when a signal quality of a detected cell of the one or more detected cells corresponding to the one or more frequencies is above an absolute threshold.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a flow diagram illustrating a method for wireless communication according to one aspect of the present disclosure.

FIG. 6 shows a wireless communication method for directly reselecting from a first radio access technology (RAT) to a third RAT according to one aspect of the disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

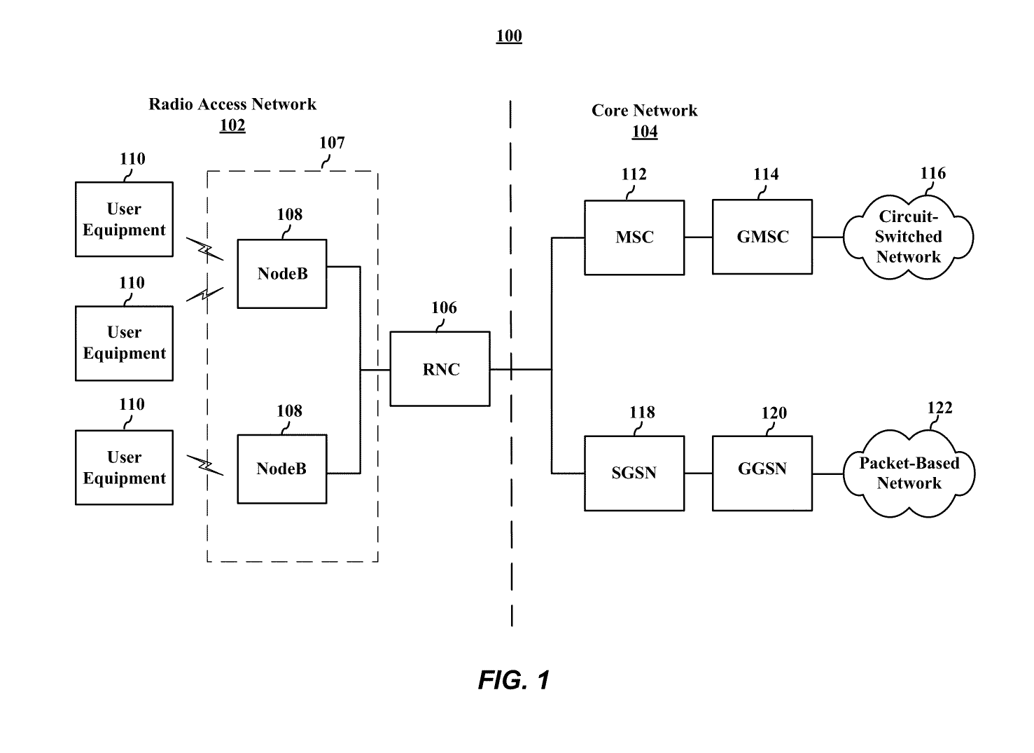

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

General packet radio service (GPRS) is designed to provide packet-data services at speeds higher than those available with standard GSM circuit switched data services. The core network 104 also supports packet-data services with a serving GPRS support node (SGSN) 118 and a gateway GPRS support node (GGSN) 120. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

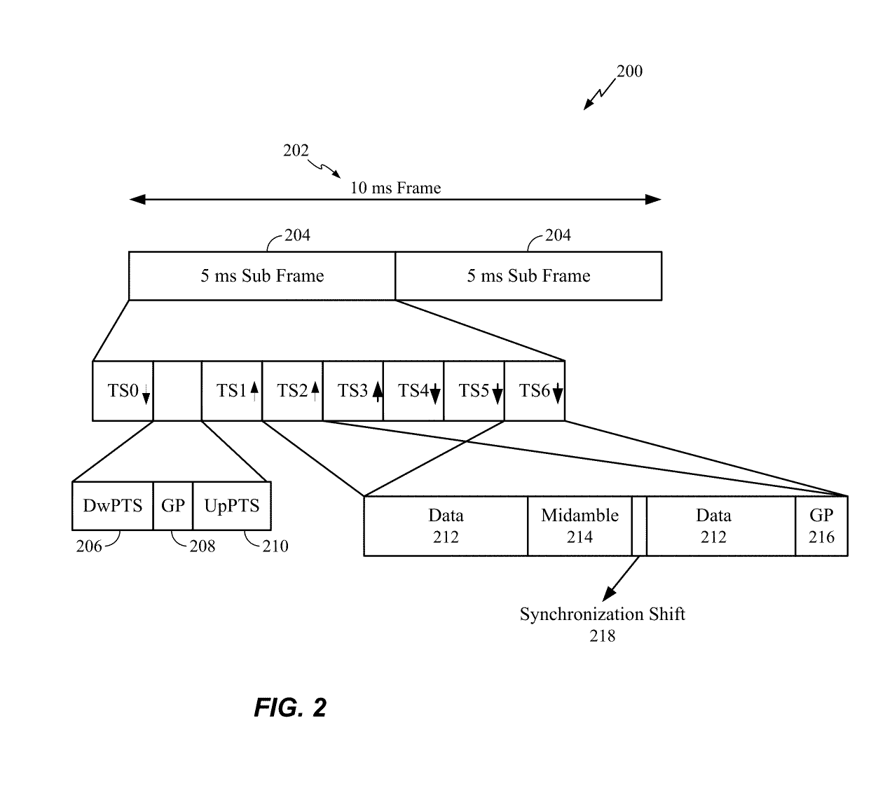

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization Shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

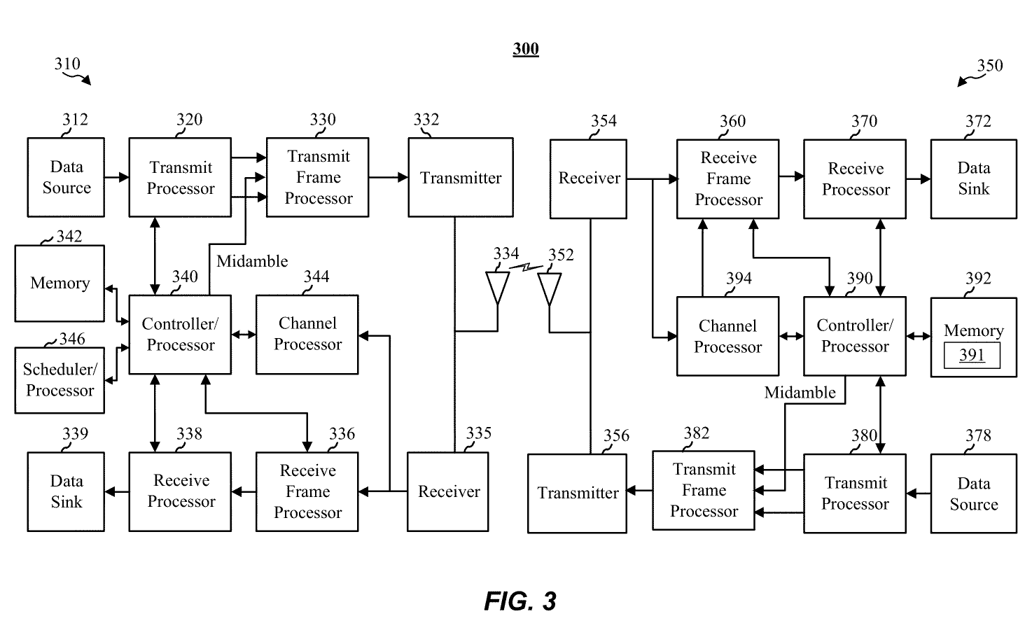

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a reselection module 391 which, when executed by the controller/processor 390, configures the UE 350 for cell reselection. A scheduler/processor 346 at the node B 310 may be used to allocate resources to the UEs and schedule downlink and/or uplink transmissions for the UEs.

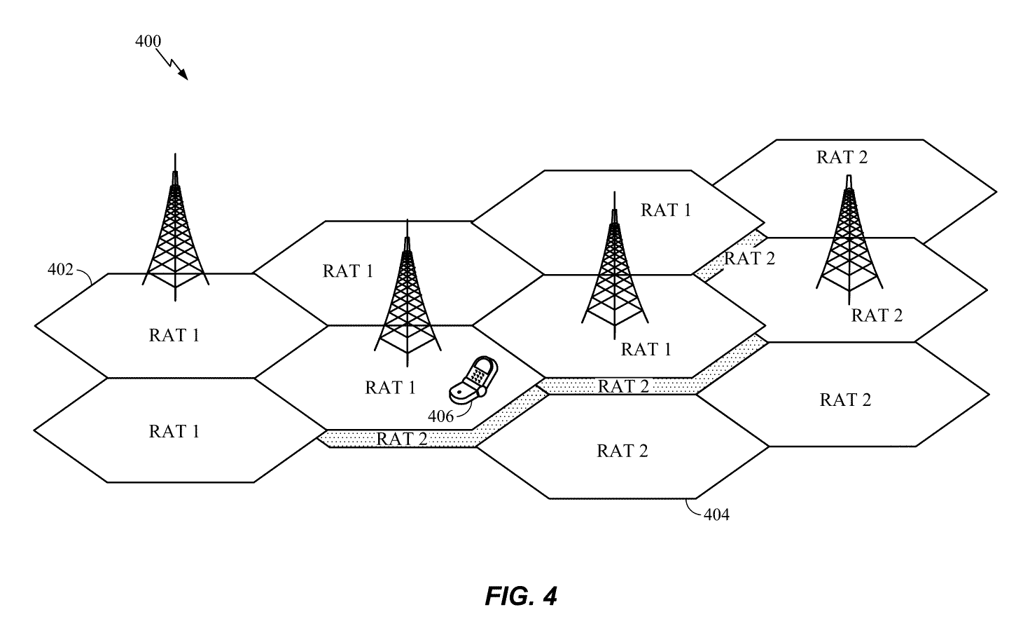

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (RAT-1), such as GSM, TD-SCDMA or Long Term Evolution (LTE) and also illustrates a newly deployed network utilizing a second type of radio access technology (RAT-2), such as a GSM, TD-SCDMA or Long Term Evolution (LTE). Those skilled in the art will appreciate that the network may contain more than two types of RATs. For example, the geographical area 400 may also include a third RAT, such as, but not limited to GSM, TD-SCDMA or Long Term Evolution (LTE).

The geographical area 400 may include RAT-1 cells 402 and RAT-2 cells 404. In one example, the RAT-1 cells are TD-SCDMA/GSM cells and the RAT-2 cells are LTE cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

In a system having multiple radio access technologies (RATs), there are times when a particular UE will operate on one system and then switch to another system. Such a switching between systems is called an inter-radio access technology (IRAT) handover (HO) or reselection between the two systems. Such handovers or reselections may be performed (e.g., for load balancing purposes), coverage holes in one network, or can be based on the type of communication desired by the UE.

The handover or cell reselection may be performed when the UE moves from a coverage area of a first type of RAT to the coverage area of a second type RAT, or vice versa. A handover or cell reselection may also be performed when there is a coverage hole or lack of coverage in one network or when there is traffic balancing between the networks of the different types of RATs.

As part of that handover or cell reselection process, while in a connected mode or discontinuous reception (DRX) mode with a first RAT (e.g., GSM), a UE may be specified to perform activities at a second (and/or third) RAT (e.g., LTE or TD-SCDMA). The discontinuous reception mode may include idle mode, cell paging channel (CELL_PCH) mode, and universal terrestrial radio access network (UTRAN) registration area paging channel (URA_PCH) mode. The UE may tune away from the first RAT to perform the activities at the second (and/or third) RAT. The activity performed when tuning away may include selecting and monitoring an indicated paging indicator channel (PICH) and paging channel (PCH), monitoring for paging information of the second (or third) RAT, monitoring and collecting system information of the second (or third) RAT (e.g., frequency of the second (or third) RAT), performing measurements (e.g., inter radio access technology measurements) for cell(s) of the first RAT and neighbor cells of the second (or third) RAT, executing cell reselection evaluation processes, and/or performing cell reselection to reselect to a neighbor cell of the second (or third) RAT when cell reselection trigger conditions are met.

For example, the cell reselection trigger conditions may be satisfied when neighbor frequencies of the third RAT (e.g., LTE) have higher priority than frequencies of the serving first RAT (e.g., GSM or TD-SCDMA) and a signal quality of a detected cell of the third RAT is above a threshold defined by the first RAT. In addition, the cell reselection trigger conditions are met when the third RAT neighbor frequencies have lower priority than that of the first RAT and the signal quality of the serving cell of the first RAT is below a threshold and the signal quality of a detected neighbor cell of the third RAT is above a threshold.

The priority of the RATs may be included in a RAT priority list from a network or defined at a user equipment (e.g., multi-RAT user equipment). For example, the RAT priority list includes the priority of RATs to be acquired by the UE, when those RATs are available. The position of a RAT on the RAT priority list indicates its acquisition order priority. For example, if LTE is listed higher than TD-SCDMA, then LTE should be acquired before TD-SCDMA.

In some networks, when the UE is camped on or connected to a serving cell of a first RAT, the UE may be informed of multiple neighbor cells. The neighbor cells may be of a same RAT and may have different frequencies or be of different RATs with same and/or different frequencies. For example, the UE may receive or be informed of LTE neighbor frequencies/cells with or without cell identifiers while camped on a TD-SCDMA cell. The neighbor cell information may be broadcast from a network (e.g., TD-SCDMA network). In some instances, only frequencies of a particular RAT (e.g., LTE) are broadcasted to the UE.

In accordance with the reselection procedure, the UE performs inter radio access technology (IRAT) measurement on neighbor cells (e.g., LTE neighbor cells/frequencies). For example, the UE may perform IRAT measurement of LTE neighbor frequencies that have higher priority or lower priority than the TD-SCDMA serving cell when a signal strength of the TD-SCDMA serving cell is below a threshold indicated by the TD-SCDMA network.

During the IRAT measurement, if the cell reselection trigger conditions are continuously met upon the expiration of a reselection timer (e.g., Treselection), the serving RAT informs the target RAT to initiate cell reselection to a detected cell of the target RAT during the IRAT measurement. The reselection timer governs when a UE may reselect to a new cell. The UE may not be permitted to reselect to a desired target RAT until expiration of the timer. Thus, the UE reselects to the target cell if the cell reselection trigger conditions are continuously met upon expiration of the reselection timer. For example, a TD-SCDMA module of the UE informs an LTE module of the UE to start cell reselection to the target LTE cell/frequency detected during the IRAT measurement. The LTE module of the UE then starts acquisition on the LTE frequency of the detected target LTE cell. The LTE module then attempts to camp on the target LTE cell after collection of broadcasted system information blocks (SIBs).

In some instances, when the UE moves from second generation (2G) coverage to both fourth generation (4G) and third generation (3G) coverage, some network systems may not allow direct reselection or handover from the second generation RAT (e.g., GSM) to a fourth generation RAT (e.g., LTE). For example, some network operators avoid direct reselection configuration (i.e., from the second generation RAT to the fourth generation RAT) because of the cost and complexity associated with updating the second generation network to broadcast fourth generation (e.g., LTE) neighbor cells. Because the second generation network system only broadcasts third generation neighbor cells and not fourth generation neighbor cells, the UE cannot directly reselect to the fourth generation RAT. As a result, these network systems implement an indirect reselection from the second generation RAT to the fourth generation RAT via the third generation RAT. For example, the UE first performs cell reselection from the second generation RAT (e.g., second generation GSM) to the third generation RAT (e.g., TD-SCDMA).

Afterwards, the UE reselects from the third generation RAT to the fourth generation RAT. For example, the user equipment collects third generation RAT system information blocks before finishing camping/registration procedures. During the registration procedure to the third generation radio access technology, the UE does not perform intra/inter radio access technology search and measurement. In some implementations, the registration procedure to the third generation radio access technology may take ten to fifteen seconds, which delays cell reselection to the fourth generation RAT. After the registration procedure is completed on the third generation RAT, the third generation radio resource control (RRC) layer passes buffered system information (e.g., system information block 19) down to layer 1 (L1) of the third generation RAT further increasing latency of the reselection. The buffered system information is passed to layer 1 when a system information block tag is not changed after collecting the master information block (MIB).

Thereafter, fourth generation (e.g., LTE) search and measurement is initiated as well as cell evaluation for inter radio access technology cell reselection, which significantly increase the latency for the user equipment to camp on the fourth generation RAT. The reselection from the third generation RAT to the fourth generation RAT may be based on a detected neighbor cell/frequency of the fourth generation RAT (e.g., LTE) received in system information (e.g., system information block (SIB) 19) from the third generation RAT. System information block 19 may also include the priority of the fourth generation RAT and the threshold for reselection. This indirect cell reselection from the second generation RAT to the fourth generation RAT via the third generation RAT significantly increases the latency for the UE to camp on the fourth generation RAT.

### Inter Radio Access Technology Cell Reselection

Aspects of the present disclosure are directed to cell reselection from a first radio access technology (RAT) (e.g., second generation RAT) to a third radio access technology (e.g., fourth generation RAT), when the first RAT does not broadcast neighbor cells of the third RAT. In one aspect of the present disclosure, when the user equipment is camped on the first RAT (e.g., second generation GSM) and the user equipment is in the coverage area of a second RAT (e.g., TD-SCDMA) and the third RAT (e.g., LTE), the UE collects system information from the second RAT when cell reselection from the first RAT to the third RAT is triggered. In one aspect of the disclosure, the collected system information includes one or more frequencies of the third RAT. The user equipment then searches for the one or more frequencies of the third RAT and measures one or more detected cells corresponding to the one or more frequencies of the third RAT. When a signal strength of a detected cell corresponding to the one or more frequencies of the third RAT is above a threshold, the UE bypasses camping on the second RAT and directly camps on the detected cell of the third RAT. For example, the UE does not analyze second RAT signal strengths to determine whether the second RAT is a viable candidate for camping.

In one aspect of the disclosure, measuring one or more detected cells corresponding to the one or more frequencies of the third RAT includes measuring signal quality of the one or more detected cells. It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc. Signal quality is intended to cover the term signal strength, as well.

In one aspect of the present disclosure, the measured signal quality of the one or more detected cells may be compared to the threshold. Cell reselection to one of the detected cells may be triggered based on whether the signal quality of the detected cell is above or below the threshold. The comparison may be part of or independent from the measuring.

In one aspect of the disclosure, the threshold is an absolute threshold. In addition, a network or the user equipment may define the threshold. For example, an indication of the threshold may be included in system information of the second RAT. Further, an indication of the threshold may be included in buffered information at the user equipment and may be based on a public land mobile network identification.

In one aspect of the disclosure, bypassing camping on the second RAT includes preventing performance of some of the activities at the second RAT. Preventing these activities at the second RAT frees up resources to be used for other procedures, such as performing activities for the third RAT. In one aspect of the disclosure, bypassing camping on the second RAT includes skipping collection of additional system information from the second RAT. Further, bypassing camping on the second RAT can include skipping registration with the second RAT.

In some implementations, the user equipment may compare signal quality of cells/frequencies of the second RAT to signal quality of cells/frequencies of the third RAT to determine whether to perform the cell reselection. However, when a priority level of one or more frequencies/cells of the third RAT is higher than a priority level of a detected frequency/cell of the second RAT, the user equipment may not compare the signal quality of the one or more frequencies/cells of the third RAT with the signal quality of the detected cell/frequency of the second RAT. Rather, the user equipment may directly perform cell reselection from a first RAT to the third RAT.

In one aspect of the disclosure, the network or the user equipment may determine the priority level. The priority level may be provided to the user equipment to facilitate the cell reselection procedure. For example, priority level information may be included in system information of the second RAT. The priority level information may also be included in information buffered at the user equipment and may be based on a public land mobile network identification.

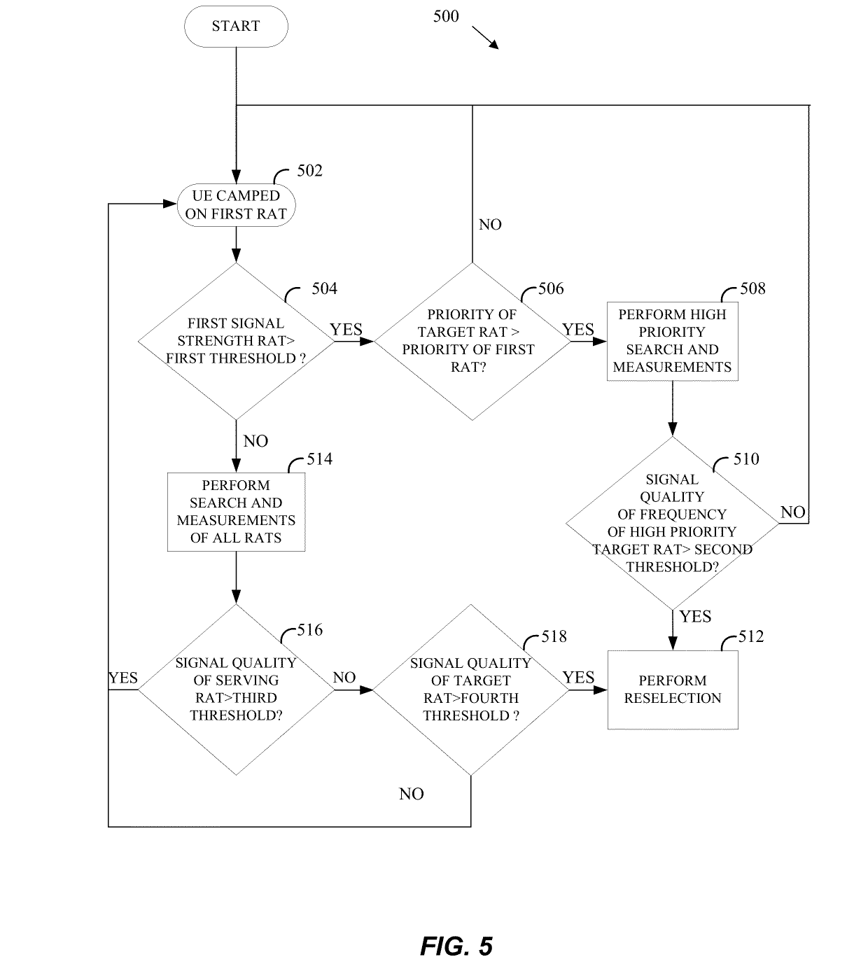

FIG. 5 shows a wireless communication method 500 according to one aspect of the disclosure. In block 502, the user equipment is camped on a suitable cell of the first RAT (e.g., second generation GSM) while in a coverage area of the second RAT (e.g., TD-SCDMA) and in a coverage area of the third RAT (e.g., LTE). While on the first RAT, the user equipment receives system information including cell reselection thresholds and/or network priorities.

In one aspect of the disclosure, the user equipment compares a signal strength of the serving first RAT to a first threshold, as in block 504. When the first RAT signal strength is higher than the first threshold, the user equipment compares a priority of a target RAT (e.g., second and/or third RAT) to a priority of the serving first RAT, as in block 506. If the priority of the target RAT is not higher than the priority of the serving first RAT, the user equipment stays on the first RAT, as in block 502. When the priority of the target RAT is higher than the priority of the serving first RAT, the user equipment performs search and measurement of cells/frequencies of the higher priority target RAT (e.g., the third RAT), as in block 508.

In block 510, the user equipment determines whether a signal quality of a cell/frequency of the higher priority target RAT is greater than a second threshold. When the signal quality of the cell/frequency of the higher priority target RAT is greater than the second threshold for a period of time, the user equipment performs cell reselection to the higher priority target RAT according to aspects of the present disclosure, as in block 512. For example, the UE collects system information from the second RAT (including third RAT neighbor frequencies), but bypasses camping on the second RAT and, bypasses registration procedures for the second RAT, before starting cell reselection procedures to the third RAT. When the signal quality of the cell/frequency of the higher priority target RAT is not greater than the second threshold for the period of time, the UE stays on the first RAT, as in block 502.

When the signal strength of the first RAT is not higher than the first threshold (514:NO), the user equipment performs search and measurement for all of the neighbor RAT cells/frequencies, regardless of their priority level, as in block 514. In block 516, the user equipment determines whether a signal quality of a cell/frequency of the serving first RAT is greater than a third threshold. When the signal quality of the cell/frequency of the first RAT is greater than the third threshold, the user equipment stays on the first RAT, as in block 502.

Otherwise, when the signal quality of the cell/frequency of the first RAT is less than the third threshold, the user equipment determines whether a signal quality of a cell/frequency of the target RAT is greater than a fourth threshold, as in block 518. When the signal quality of the cell/frequency of the target RAT is not greater than the fourth threshold, the user equipment stays on the first RAT, as in block 502. Otherwise, when the signal quality of the cell/frequency of the target RAT is greater than the fourth threshold the user equipment performs cell reselection to the target RAT according to aspects of the present disclosure, as in block 512.

Bypassing camping on the second RAT and bypassing registration procedures for the second RAT, while obtaining neighbor frequencies from the second RAT, according to aspects of the present disclosure, speeds up the reselection procedure to the third RAT.

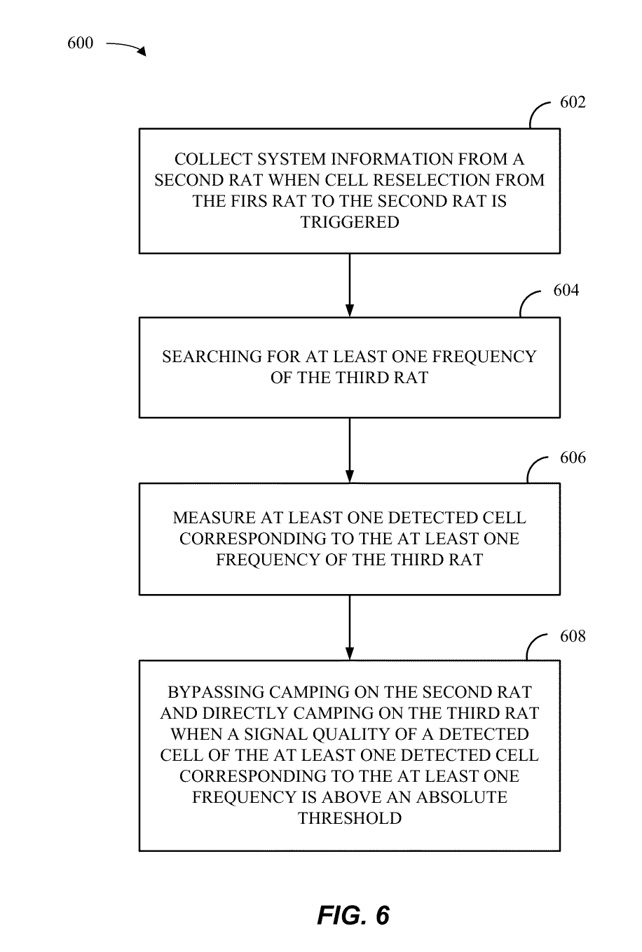

FIG. 6 shows a wireless communication method 600 for directly reselecting from a first radio access technology (RAT) to a third RAT according to one aspect of the disclosure. In this example, the first RAT does not provide neighbor frequencies of the third RAT. Therefore, the UE first starts reselection to a second RAT. The UE collects system information from a second RAT when cell reselection from the first RAT to the second RAT is triggered, as shown in block 602. The system information includes one or more frequencies of the third RAT.

The UE searches for the one or more frequencies of the third RAT, as shown in block 604. The UE measures one or more detected cells corresponding to the one or more frequencies of the third RAT, as shown in block 606. The UE then bypasses camping on the second RAT and directly camps on the third RAT when a signal quality of a detected cell of the one or more detected cells corresponding to the one or more frequencies is above an absolute threshold, as shown in block 608.

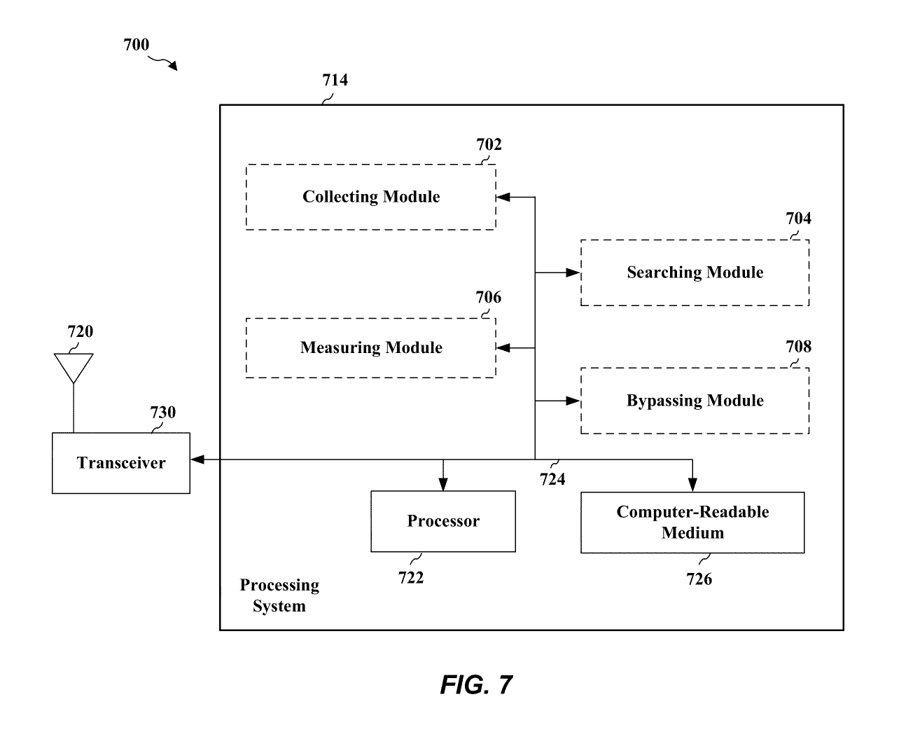

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, 706, 708 and the non-transitory computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a collecting module 702 for collecting system information from a second RAT when cell reselection from a first RAT to a second RAT is triggered. The processing system 714 includes a searching module 704 for searching for one or more frequencies of the third RAT. The processing system 714 includes a measuring module 706 for measuring one or more detected cells corresponding to the one or more frequencies of the third RAT. The processing system 714 includes a bypassing module 708 for bypassing camping on the second RAT and directly camping on the third RAT when a signal strength of a cell corresponding to the one or more frequencies is above an absolute threshold. The modules may be software modules running in the processor 722, resident/stored in the computer-readable medium 726, one or more hardware modules coupled to the processor 722, or some combination thereof. The processing system 714 may be a component of the UE 350 and may include the memory 392, and/or the controller/processor 390.

In one configuration, an apparatus such as a UE is configured for wireless communication including means for collecting. In one aspect, the collecting means may be the antennas 352/720, the receiver 354, the transceiver 730, the channel processor 394, the receive frame processor 360, the receive processor 370, the controller/processor 390, the memory 392, the reselection module 391, the collecting module 702, and/or the processing system 714 configured to perform the aforementioned means. The UE is also configured to include means for searching. In one aspect, the searching means may be the antennas 352/720, the receiver 354, the transceiver 730, the channel processor 394, the receive frame processor 360, the receive processor 370, the controller/processor 390, the memory 392, reselection module 391, the searching module 704 and/or the processing system 714 configured to perform the aforementioned means. In one configuration, the means functions correspond to the aforementioned structures. In another aspect, the aforementioned means may be any module or any apparatus configured to perform the functions recited by the aforementioned means.

The UE is also configured to include means for measuring. In one aspect, the measuring means may be the antennas 352/720, the receiver 354, the transceiver 730, the channel processor 394, the receive frame processor 360, the receive processor 370, the controller/processor 390, the memory 392, reselection module 391, the measuring module 706 and/or the processing system 714 configured to perform the aforementioned means. The UE is also configured to include means for bypassing. In one aspect, the bypassing means may be the antennas 352/720, the receiver 354, the channel processor 394, the receive frame processor 360, the receive processor 370, the transmitter 356, the transmit frame processor 382, the transmit processor 380, the controller/processor 390, the memory 392, reselection module 391, the bypassing module 708 and/or the processing system 714 configured to perform the aforementioned means. In one configuration, the means functions correspond to the aforementioned structures. In another aspect, the aforementioned means may be any module or any apparatus configured to perform the functions recited by the aforementioned means.

Several aspects of a telecommunications system have been presented with reference to LTE, TD-SCDMA and GSM systems. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of directly reselecting from a first radio access technology (RAT) to a third RAT, comprising:
collecting system information from a second radio access technology (RAT) when cell reselection from the first RAT to the second RAT is triggered, the system information including at least one frequency of the third RAT;
searching for the at least one frequency of the third RAT;
measuring at least one detected cell corresponding to the at least one frequency of the third RAT; and
bypassing camping on the second RAT and directly camping on the third RAT when a signal quality of a detected cell of the at least one detected cell corresponding to the at least one frequency is above an absolute threshold.

2. The method of claim 1, in which measuring comprises comparing the signal quality of the at least one detected cell corresponding to the at least one frequency of the third RAT with the absolute threshold.

3. The method of claim 1, in which the absolute threshold is from system information of the second RAT.

4. The method of claim 1, in which the absolute threshold is from buffered information in a user equipment (UE) and is based at least in part on public land mobile network (PLMN) identifier.

5. The method of claim 1, in which bypassing comprises skipping collection of additional system information from the second RAT.

6. The method of claim 1, in which bypassing comprises skipping registration with the second RAT.

7. The method of claim 1, in which measuring does not compare a signal strength of the at least one frequency of the third RAT with a cell of the second RAT when a priority level of the at least one frequency of the third RAT is higher than a priority level of the frequency of the second RAT.

8. The method of claim 7, in which the priority level is from system information of the second RAT.

9. The method of claim 7, in which the priority level is from buffered information in a user equipment and is based at least in part on public land mobile network identifier.

10. An apparatus for directly reselecting from a first radio access technology (RAT) to a third RAT, comprising:
means for collecting system information from a second radio access technology (RAT) when cell reselection from the first RAT to the second RAT is triggered, the system information including at least one frequency of the third RAT;
means for searching for the at least one frequency of the third RAT;
means for measuring at least one detected cell corresponding to the at least one frequency of the third RAT; and
means for bypassing camping on the second RAT and directly camping on the third RAT when a signal quality of a detected cell of the at least one detected cell corresponding to the at least one frequency is above an absolute threshold.

11. The apparatus of claim 10, in which measuring means comprises means for comparing the signal quality of the at least one detected cell corresponding to the at least one frequency of the third RAT with the absolute threshold.

12. The apparatus of claim 10, in which the absolute threshold is from system information of the second RAT.

13. The apparatus of claim 10, in which the absolute threshold is from buffered information in a user equipment (UE) and is based at least in part on public land mobile network (PLMN) identifier.

14. The apparatus of claim 10, in which the bypassing means comprises means for skipping collection of additional system information from the second RAT.

15. The apparatus of claim 10, in which the bypassing means comprises means for skipping registration with the second RAT.

16. An apparatus for directly reselecting from a first radio access technology (RAT) to a third RAT, comprising:
a memory; and
at least one processor coupled to the memory and configured:
to collect system information from a second radio access technology (RAT) when cell reselection from the first RAT to the second RAT is triggered, the system information including at least one frequency of the third RAT;
to search for the at least one frequency of the third RAT;
to measure at least one detected cell corresponding to the at least one frequency of the third RAT; and
to bypass camping on the second RAT and directly camping on the third RAT when a signal quality of a detected cell of the at least one detected cell corresponding to the at least one frequency is above an absolute threshold.

17. The apparatus of claim 16, in which the at least one processor is further configured to measure by comparing the signal quality of the at least one detected cell corresponding to the at least one frequency of the third RAT with the absolute threshold.

18. The apparatus of claim 16, in which the absolute threshold is from system information of the second RAT.

19. The apparatus of claim 16, in which the absolute threshold is from buffered information in a user equipment (UE) and is based at least in part on public land mobile network (PLMN) identifier.

20. The apparatus of claim 16, in which the at least one processor is configured to bypass camping by skipping collection of additional system information from the second RAT.

21. The apparatus of claim 16, in which the at least one processor is configured to bypass camping by skipping registration with the second RAT.

22. The apparatus of claim 16, in which the at least one processor is configured to measure by not comparing a signal strength of the at least one frequency of the third RAT with a cell of the second RAT when a priority level of the at least one frequency of the third RAT is higher than a priority level of the frequency of the second RAT.

23. The apparatus of claim 22, in which the priority level is from system information of the second RAT.

24. The apparatus of claim 22, in which the priority level is from buffered information in a user equipment and is based at least in part on public land mobile network identifier.

25. A computer program product for directly reselecting from a first radio access technology (RAT) to a third RAT, comprising:
a non-transitory computer-readable medium having program code recorded thereon, the program code comprising:
program code to collect system information from a second radio access technology (RAT) when cell reselection from the first RAT to the second RAT is triggered, the system information including at least one frequency of the third RAT;
program code to search for the at least one frequency of the third RAT;
program code to measure at least one detected cell corresponding to the at least one frequency of the third RAT; and
program code to bypass camping on the second RAT and directly camping on the third RAT when a signal quality of a detected cell of the at least one detected cell corresponding to the at least one frequency is above an absolute threshold.

26. The computer program product of claim 25, in which the program code to measure further comprises program code to compare the signal quality of the at least one detected cell corresponding to the at least one frequency of the third RAT with the absolute threshold.

27. The computer program product of claim 25, in which the absolute threshold is from system information of the second RAT.

28. The computer program product of claim 25, in which the absolute threshold is from buffered information in a user equipment (UE) and is based at least in part on public land mobile network (PLMN) identifier.

29. The computer program product of claim 25, in which the program code to bypass further comprises program code to skip collection of additional system information from the second RAT.

30. The computer program product of claim 25, in which the program code to bypass further comprises program code to skip registration with the second RAT.
